(19) United States
(12) Patent Application Publication
(10) Pub. No.: US 2014/0029972 A1
(43) Pub. Date: Jan. 30, 2014

(54) ELECTROPHOTOGRAPHIC MAGNETIC SEALING MEMBER AND ELECTROPHOTOGRAPHIC CARTRIDGE

(71) Applicant: CANON KASEI KABUSHIKI KAISHA, Tsukuba-shi (JP)

(72) Inventors: Keisuke Sakai, Toride-shi (JP); Takaaki Kohtaki, Mishima-shi (JP); Junichi Ootake, Ryugasaki-shi (JP)

(73) Assignee: CANON KASEI KABUSHIKI KAISHA, Tsukuba-shi (JP)

(21) Appl. No.: 13/954,393

(22) Filed: Jul. 30, 2013

(30) Foreign Application Priority Data
Jul. 30, 2012 (JP) 2012-168430

(51) Int. Cl. G03G 15/08

(52) U.S. Cl. CPC G03G 15/0898; G03G 15/0881
USPC 399/104

(57) ABSTRACT

Provided is an electrophotographic magnetic sealing member for sealing magnetic toner contains a magnetic material and a binder resin. The magnetic material at least includes Nd and Fe, and further includes at least one element selected from the group consisting of Sr and Ba, at least one element selected from the group consisting of Pr and La, at least one element selected from the group consisting of B, Si, In, and P, and an Al element. The magnetic material has a residual magnetic flux density of 270 mT to 500 mT, an intrinsic coercive force of 400 kA/m to 850 kA/m, and a maximum energy product of 10.0 kJ/m³ to 40.0 kJ/m³. The electrophotographic magnetic sealing member contains 3.0 parts by mass to 15.0 parts by mass of the binder resin based on 100.0 parts by mass of the magnetic material.

### BACKGROUND OF THE INVENTION

1. Field of the Invention

The present invention relates to a magnetic sealing member to prevent magnetic toner from leaking from a container storing the magnetic toner in an electrophotographic apparatus such as a copy machine and a laser beam printer, and an electrophotographic cartridge using the same.

2. Description of the Related Art

An electrophotographic apparatus such as a copy machine and a laser beam printer conventionally includes a sealing member which prevents magnetic toners from flowing outside of a development area at both ends of a developer carrying member. A noncontact magnetic sealing member utilizing magnetic attractive force is used as the member.

Conventionally, a plastic Nd—Fe—B rare earth magnet has been used as a noncontact magnetic sealing member. However, the addition amount of magnetite to the toner has been increased due to the reduction in diameter of toner particles in a recent trend. As a result, the toner is more strongly attracted toward a magnetic sealing part than before, causing degradation of the toner due to the strong friction with the magnetic sealing part. Examples of a method for reducing the magnetic force of the magnetic seal of the conventional plastic Nd—Fe—B rare earth magnet include (1) a method by increasing the proportion of a binder resin (Japanese Patent No. 4438197), (2) a method by reducing magnetization voltage during magnetization, and (3) a method of reducing magnetic force by blending ferrite or the like (Japanese Patent Application Laid-Open No. 2006-13055).

The method (1) in which the ratio of a binder resin is increased causes a large contraction after molding. This causes fine irregularities in shape due to the difference in the degree of contraction between a resin-rich portion and a magnetic-substance-rich portion, which can be observed in a minute part of the sealing member. The toner is apt to accumulate at a spot having large irregularities, at which the degradation of toner is accelerated. Although the method (2) in which magnetization voltage is reduced suppresses and controls the capacity of a magnet in mid-course, it is difficult to make an accurate magnetization pattern due to the difficulty in maintaining a constant timing for control. As a result, the partial leakage of toner is apt to occur. The method (3) in which ferrite is blended to reduce the magnetic force has insufficient effect on prevention of the degradation of toner. An example of addition of Co has been also disclosed (Japanese Patent Application Laid-Open No. 2005-32745). The method of adding Co is apt to cause leakage of toner due to the small intrinsic coercive force (iHc) of the magnet for use as a magnet seal. This results from the effect of the magnetic force of a magnet roll installed in a development sleeve on the use as a sealing member.

### SUMMARY OF THE INVENTION

An object of the present invention is to provide a magnetic sealing member which achieves sufficient sealing ability for a toner having small particle diameter, with a proper magnetic force, without being influenced very much by the magnetism of a magnet roll at the magnetic sealing part of an electrophotographic developing unit, and prevents the degradation of toner at the electrophotographic magnetic sealing part so as to produce a high quality printed image having no toner fogging, toner dropping, or the like. Another object of the present invention is to provide an electrophotographic cartridge using the same.

As a result of comprehensive deliberations, the present inventors have prepared the following composition for a magnetic sealing member having desired magnetic properties to prevent the leakage of toner and reduce the degradation of toner as well.

In an electrophotographic magnetic sealing member containing a magnetic material and a binder resin for sealing a magnetic toner having a weight-average particle diameter of 5.0 μm or more and less than 9.0 μm with a magnetic substance amount in the magnetic toner of 50 parts by mass or more and less than 125 parts by mass, the magnetic material at least includes neodymium (Nd) and iron (Fe), and further includes at least one element selected from the group consisting of strontium (Sr) and barium (Ba), at least one element selected from the group consisting of praseodymium (Pr) and lanthanum (La), at least one element selected from the group consisting of boron (B), silicon (Si), indium (In), and phosphorus (P), and an aluminum (Al) element, the magnetic material has a residual magnetic flux density (Br) of 270 mT or more and 500 mT or less, an intrinsic coercive force (iHc) of 400 kA/m or more and 850 kA/m or less, and a maximum energy product (BHmax) of 10.0 kJ/m³ or more and 40.0 kJ/m³ or less, and the electrophotographic magnetic sealing member contains 3.0 parts by mass or more and 15.0 parts by mass or less of the binder resin based on 100.0 parts by mass of the magnetic material.

The magnetic material may at least include 3.0 atomic % or more and 12.0 atomic % or less of neodymium (Nd) and 65.0 atomic % or more and 85.0 atomic % or less of iron (Fe), and further includes 0.10 atomic % or more and 4.0 atomic % or less of at least one element selected from the group consisting of strontium (Sr) and barium (Ba), 0.10 atomic % or more and 9.0 atomic % or less of at least one element selected from the group consisting of praseodymium (Pr) and lanthanum (La), 4.0 atomic % or more and 15.0 atomic % or less of at least one element selected from the group consisting of boron (B), silicon (Si), indium (In), and phosphorus (P), and 1.5 atomic % or more and 8.0 atomic % or less of an aluminum (Al) element.

Alternatively, the magnetic material may at least include 4.5 atomic % or more and 10.0 atomic % or less of neodymium (Nd) and 67.0 atomic % or more and 80.0 atomic % or less of iron (Fe), and further includes 0.20 atomic % or more and 3.0 atomic % or less of at least one element selected from the group consisting of strontium (Sr) and barium (Ba), 3.0 atomic % or more and 8.5 atomic % or less of at least one element selected from the group consisting of praseodymium (Pr) and lanthanum (La), 5.0 atomic % or more and 11.5 atomic % or less of at least one element selected from the group consisting of boron (B), silicon (Si), indium (In), and phosphorus (P), and 2.0 atomic % or more and 7.5 atomic % or less of an aluminum (Al) element.

The magnetic material may have a residual magnetic flux density (Br) of 290 mT or more and 480 mT or less, an intrinsic coercive force (iHc) of 420 kA/m or more and 750 kA/m or less, and a maximum energy product (BHmax) of 12.0 kJ/m³ or more and 38.0 kJ/m³ or less.

The magnetic material may be isotropic.

The binder resin may include at least one resin selected from the group consisting of polyamide, polyphenylene sulfide, polystyrene, polyethylene, polypropylene, and polyethylene terephthalate.

An electrophotographic cartridge using an electrophotographic magnetic sealing member includes the electrophotographic magnetic sealing member described above as the electrophotographic magnetic sealing member.

The present invention provides a magnetic sealing member which achieves sufficient sealing ability for a toner having small particle diameter, with a proper magnetic force, without being influenced very much by the magnetism of a magnet roll at the magnetic sealing part of an electrophotographic developing unit, and prevents the degradation of toner at the electrophotographic magnetic sealing part so as to produce a high quality printed image having no toner fogging, toner dropping, or the like; and an electrophotographic cartridge using the same.

Further features of the present invention will become apparent from the following description of exemplary embodiments with reference to the attached drawings.

### BRIEF DESCRIPTION OF THE DRAWINGS

FIG. 1 is a perspective view illustrating a magnetic sealing member according to one embodiment of the present invention.

FIG. 2 is a side view illustrating a magnetic sealing member and a (polar anisotropic) magnetization pattern according to one embodiment of the present invention.

FIG. 3 is a cross-sectional view taken from a line 3-3 of FIG. 2.

FIG. 4 is a side view illustrating a magnetic sealing member and a (radial) magnetization pattern according to one embodiment of the present invention.

FIG. 5 is a cross-sectional view taken from a line 5-5 of FIG. 4.

### DESCRIPTION OF THE EMBODIMENTS

Preferred embodiments of the present invention will now be described in detail in accordance with the accompanying drawings.

The present invention provides an electrophotographic magnetic sealing member which prevents the leakage of magnetic toner, and an electrophotographic cartridge using the electrophotographic magnetic sealing member.

Shape of Sealing Member

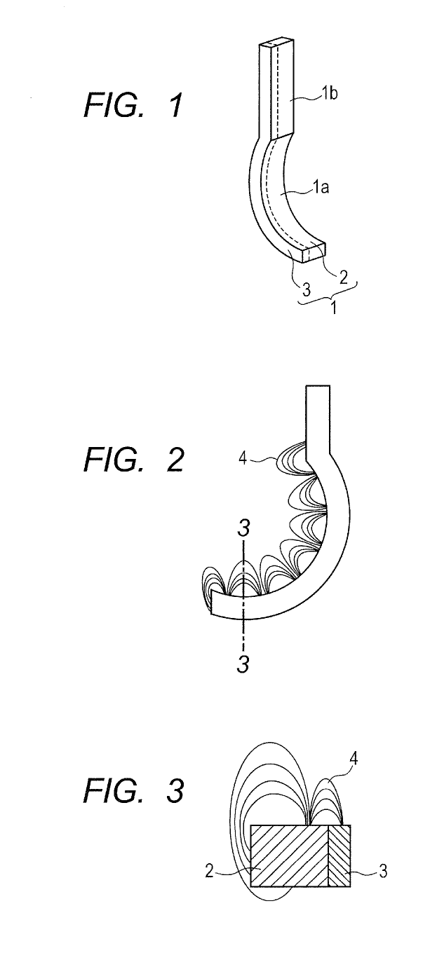

An embodiment of the present invention will now be described below with reference to the drawings; however, the invention is not limited thereto. FIG. 1 illustrates an embodiment of the magnetic sealing member of the present invention. The magnetic sealing member includes a magnet part and a yoke part to converge the magnet field thereof. The magnetic sealing member has, for example, a circular arc surface (cylindrical surface) part 1a of about 120° or more and 240° or less and a linear part 1b. The magnetic sealing member includes, for example, a sealing magnetic pole layer with a width of 1 mm or more and 5 mm or less and a magnetic flux converging layer (yoke member) with a width of 0.3 mm or more and 3 mm or less in the thickness direction. The inner circumference of the circular arc of the present embodiment has a radius (R) of, for example, 3.0 mm or more and 15.0 mm or less.

Material for Forming Sealing Magnetic Pole Layer

Magnetic Material

Examples of the source magnetic powder of the magnetic material for use in the present invention include neodymium (Nd), iron (Fe), strontium (Sr), barium (Ba), praseodymium (Pr), lanthanum (La), indium (In), aluminum (Al), boron (B), silicon (Si), and phosphorus (P); and an oxide, a carbonate, a hydroxide, a sulfate, a chloride, or a phosphide (indium phosphide (InP)) which contains these elements.

The magnetic material of the present invention at least contains neodymium (Nd) and iron (Fe), and further includes at least one element selected from the group consisting of strontium (Sr) and barium (Ba), at least one element selected from the group consisting of praseodymium (Pr) and lanthanum (La), at least one element selected from the group consisting of boron (B), silicon (Si), indium (In), and phosphorus (P), and an aluminum (Al) element.

Examples of the magnetic material can include one which at least includes 3.0 atomic % or more and 12.0 atomic % or less of neodymium (Nd) and 65.0 atomic % or more and 85.0 atomic % or less of iron (Fe), and further includes 0.10 atomic % or more and 4.0 atomic % or less of at least one element selected from the group consisting of strontium (Sr) and barium (Ba), 0.10 atomic % or more and 9.0 atomic % or less of at least one element selected from the group consisting of praseodymium (Pr) and lanthanum (La), 4.0 atomic % or more and 15.0 atomic % or less of at least one element selected from the group consisting of boron (B), silicon (Si), indium (In), and phosphorus (P), and 1.5 atomic % or more and 8.0 atomic % or less of an aluminum (Al) element.

A neodymium (Nd) content of less than 3.0 atomic % causes the leakage of the magnetic toner from the sealing member due to insufficient magnetic force as a magnetic seal. A Nd content of more than 12.0 atomic % allows a large amount of toner to be captured at the sealing part by the excessively strong magnetic force, causing reduction in image density at the end part of a printed image and toner fogging on a printed image due to the accelerated degradation of toner.

An iron (Fe) content of less than 65.0 atomic % also causes the leakage of the magnetic toner from the sealing member due to insufficient magnetic force as a magnetic seal. A Fe content of more than 85.0 atomic % allows a large amount of toner to be captured at the sealing part by the excessively strong magnetic force, causing reduction in image density at the end part of a printed image and toner fogging on a printed image due to the accelerated degradation of toner, as in the case of neodymium.

A content of less than 0.10 atomic % of at least one element selected from the group consisting of strontium (Sr) and barium (Ba) results in reduced residual magnetic flux density (Br), causing the leakage of the magnetic toner from the sealing member due to the insufficient maximum energy product as a magnet.

A content of more than 4.0 atomic % thereof results in a large toner-capturing effect and a toner degradation effect as described above due to an excessively large maximum energy product, notably causing defects in an image.

4.0 atomic % or more and 15.0 atomic % or less of at least one element selected from the group consisting of boron (B), silicon (Si), indium (In), and phosphorus (P) may be contained. A content of less than 4.0 atomic % thereof has only weak effect on enhancing the magnetic force by the addition, causing the leakage of toner due to the reduced magnetic force at the sealing part. A content of more than 15.0 atomic % thereof has a negative effect of reducing the saturation magnetization of ferrite itself, spoiling the effect of addition.

An aluminum (Al) element content of less than 1.5 atomic % reduces the intrinsic coercive force (iHc), allowing an external magnetic field, in particular the magnetic field at the end part of a magnet roll installed in a development sleeve, to have a larger effect. As a result, the sealing ability may be partially worsened. An Al content of more than 8.0 atomic % reduces the residual magnetic flux density (Br), causing the leakage of the magnetic toner from the sealing member due to the insufficient maximum energy product as a magnet.

More preferably, the magnetic material may at least include 4.5 atomic % or more and 10.0 atomic % or less of neodymium (Nd) and 67.0 atomic % or more and 80.0 atomic % or less of iron (Fe), and further includes 0.20 atomic % or more and 3.0 atomic % or less of at least one element selected from the group consisting of strontium (Sr) and barium (Ba), 3.0 atomic % or more and 8.5 atomic % or less of at least one element selected from the group consisting of praseodymium (Pr) and lanthanum (La), 5.0 atomic % or more and 11.5 atomic % or less of at least one element selected from the group consisting of boron (B), silicon (Si), indium (In), and phosphorus (P), and 2.0 atomic % or more and 7.5 atomic % or less of an aluminum (Al) element, in order to achieve the objects of the present invention.

In an aspect, an silicon compound, indium phosphide, an aluminum compound or the like can be added to the rare earth element magnetic powder (RFeB (Nd, Pr and La)) and ferrite magnetic powder (Sr and Ba), as needed.

As described above, it is important for a magnetic sealing member to maintain a certain magnetic force as a magnet while reducing the influence of an external magnetic field (magnetic field by a magnet roll at the end part of a development sleeve) as much as possible. Japanese Patent Application Laid-Open No. 2005-32745 discloses that the intrinsic coercive force (iHc) is enhanced by the addition of Al₂O₃ or Cr₂O₃, and that the residual magnetic flux density (Br) is reduced by the addition of Al₂O₃ or Cr₂O₃. In the present application, aluminum is added without addition of cobalt in order to enhance the intrinsic coercive force (iHc), suppressing reduction in the residual magnetic flux density (Br) to an extent. As a result, a magnet having sufficient magnetic properties as a magnet seal can be obtained. A further fine adjustment can be performed by addition of silicon or indium phosphide (InP).

The maximum energy product (BHmax) is an important magnetic property of a magnetic seal as an index for the toner sealing force. A magnetic seal can have magnetic properties including a maximum energy product (BHmax) of 10.0 kJ/m³ or more and 40.0 kJ/m³ or less, a residual magnetic flux density (Br) of 270 mT or more and 500 mT or less, and an intrinsic coercive force (iHc) of 400 kA/m or more and 850 kA/m or less.

A maximum energy product (BHmax) of less than 10.0 kJ/m³ causes more frequent occurrence of toner leakage from a gap between the sealing member and a development sleeve due to the weakened toner control force at the sealing part. A maximum energy product (BHmax) of more than 40.0 kJ/m³ causes more frequent occurrence of toner accumulation at the sealing part. As a result, an external additive is separated from the toner matrix or embedded in the matrix due to the friction of toner between a development sleeve and a sealing member or a container, resulting in worsened flowability of toner to cause charging defect and toner fogging on an image.

More preferable magnetic properties include a residual magnetic flux density (Br) of 290 mT or more and 480 mT or less, an intrinsic coercive force (iHc) of 420 kA/m or more and 750 kA/m or less, and a maximum energy product (BHmax) of 12.0 kJ/m³ or more and 38.0 kJ/m³ or less.

A residual magnetic flux density (Br) of less than 270 mT causes more frequent occurrence of the leakage of toner in the case where the maximum energy product (BHmax) is reduced as described above.

A residual magnetic flux density (Br) of more than 500 mT allows the maximum energy product (BHmax) to exceed the above-described range so as to accelerate the degradation of toner, or allows an external magnetic field to have influence due to the reduced intrinsic coercive force (iHc) in the case of having the maximum energy product (BHmax) in such range. This reduces the magnetic sealing properties, causing more frequent occurrence of the leakage of toner.

An intrinsic coercive force (iHc) of less than 400 kA/m allows an external magnetic field to have influence, and reduces the maximum energy product (BHmax) so as to weaken the magnetic sealing properties as described above, causing more frequent occurrence of the leakage of toner. An intrinsic coercive force (iHc) of more than 850 kA/m allows the maximum energy product (BHmax) to exceed the above-described range so as to accelerate the degradation of toner, while allowing an external magnetic field to have small influence.

In addition, the following was found in the relation between the residual magnetic flux density (Br) and the intrinsic coercive force (iHc).

The maximum energy product (BHmax) is an important magnetic property of magnetic sealing as an index representing the toner sealing force and the influence of an external magnetic field. The ratio of the residual magnetic flux density (Br) to the intrinsic coercive force (iHc) represents the degree of change relative to an external magnetic field. A ratio (mT/(kA/m)) of the residual magnetic flux density (Br) to the intrinsic coercive force (iHc) of less than 0.4 causes occurrence of the leakage of toner due to insufficient magnetic force as a magnetic sealing member.

A ratio (mT/(kA/m)) of the residual magnetic flux density (Br) to the intrinsic coercive force (iHc) of more than 1.0 allows toner to be captured in the neighborhood of a sealing part, accelerating the degradation of the toner, or causing the occurrence of the leakage of toner due to the unstable amount of toner at the sealing part under influence of an external magnetic field. A ratio (mT/(kA/m)) of the residual magnetic flux density (Br) to the intrinsic coercive force (iHc) of 0.42 or more and 0.76 or less is more preferred to achieve the objects of the present invention.

The magnetic powder may be pulverized and then used as granulated magnetic powder. The pulverized particles allow a magnetic force to be easily controlled during magnetization after molding due to the small size of the particles. The magnetic powder may be properly surface treated as needed. For example, the magnetic powder may be subject to a coupling treatment in advance and then blended with a binder resin. Various types of coupling agents can be used in this case. Examples of the coupling agent include a silane coupling agent such as i-butyl trimethoxysilane, γ-ureid propyltriethoxysilane, γ-benzil aminopropyltrimethoxysilane, and N-β-(aminoethyl)-γ-aminopropyltrimethoxysilane; a titanate coupling agent such as isopropyltriisostearoyltitanate and isopropyltri(N-aminoethyl-aminoethyl)titanate; and an aluminum coupling agent such as acetoalkoxy aluminum diisopropylate.

The magnet powder can have an average particle diameter of 0.5 μm or more and 500 μm or less, more preferably 0.5 μm or more and 100 μm or less. In this range, the magnet powder can be easily blended with a resin binder, so that a magnetic sealing member having excellent uniformity of the magnetic powder can be easily obtained. A diameter of 100 μm or less thereof, in particular, allows a resin magnet having excellent magnetic properties to be easily obtained.

Binder Resin

A thermoplastic resin can be used as a binder resin. The thermoplastic resin as a binder is not specifically limited as long as a predetermined shape can be formed. More specifically, examples of the thermoplastic resin include a polyamide resin (PA) such as nylon 6 and nylon 12, a polyphenylene sulfide resin (PPS), a polystyrene resin (PS), polyethylene terephthalate resin (PET), a polybutylene terephthalate resin (PBT), a polypropylene (PP), and a polyethylene (PE). One or a mixture of two or more of these may be used. In particular of these, a polyamide resin (PA) and a polyphenylene sulfide resin (PPS) are favorably used in terms of formability, compatibility with magnetic powder and mechanical properties. The combination of a resin binder and a magnetic powder may be properly selected depending on the magnetic sealing properties required for an electrophotographic apparatus.

The binder resin in an amount of 3.0 parts by mass or more and 15.0 parts by mass or less can be contained relative to the magnetic material in an amount of 100.0 parts by mass including elements to constitute the magnetic powder as described above. A content less than 3.0 parts by mass thereof causes insufficient adhesion. A content more than 15.0 parts by mass thereof results in insufficient mechanical strength. A content of 4.0 parts by mass or more and 13.0 parts by mass or less thereof is more preferable in order to maintain stable strength.

Yoke Member

A pressed component made of magnetic iron or magnetic stainless steel is usually used as a yoke member. Examples of the soft magnetic powder for a yoke include Fe—Si—Al powder, Fe—Si powder, Ni—Fe powder, Fe—Co powder, iron powder, and soft ferrite powder. One or plurality of these may be molded for use.

Molding Process

A yoke member is arranged in a mold cavity. Subsequently, a raw material composition including the magnetic powder and the resin binder is injected into a mold by an injection molding machine, so as to be molded into the shape of the magnetic sealing member.

In the present invention, the raw material composition as a molten mixture is injected by an injection molding machine at 200° C. or higher and 330° C. or lower. At a temperature of 200° C. or higher, the resin has good flowabilty so that the raw material composition can easily run through the mold cavity. At a temperature of 330° or lower, a molding trouble due to thermal decomposition of material can be easily prevented.

Magnetization Process of Magnetic Sealing Member

In a process of magnetizing a sealing member, a magnetic field is applied after molding with an electromagnet in the case of an isotropic magnet. In contrast, a magnetic field is applied during molding with, for example, a permanent magnet arranged in a molding mold so as to allow the magnet powder to be oriented during molding in the case of an anisotropic magnet.

Magnetization State of Magnetic Sealing Member

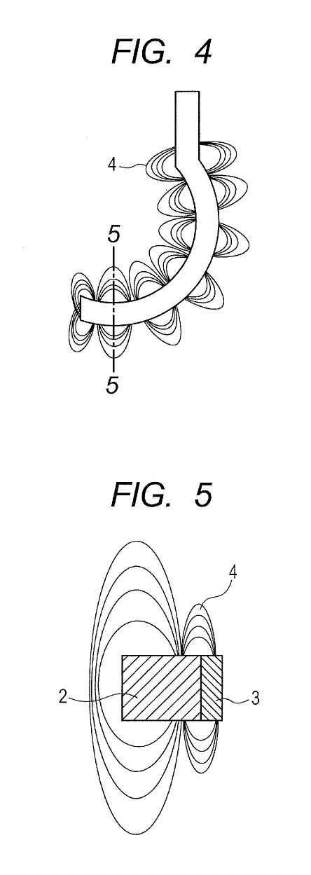

In an embodiment of the magnetic sealing member, a plurality of anisotropic N and S magnetic poles are alternately magnetized as illustrated in FIG. 2, or a plurality of N and S magnetic poles are magnetized in a radial direction of the inner circumferential surface as illustrated in FIG. 4. The magnetic force pattern is not limited thereto, but may be properly arranged depending on a development mechanism. As illustrated in FIG. 3, the lines of magnetic force radiated from a resin magnet 2 are converged into a yoke 3.

Magnetic Toner

The magnetic toner for use in the present invention can have a weight-average particle diameter of 5.0 μm or more and less than 9.0 μm and a magnetic substance amount in the magnetic toner of 50 parts by mass or more and less than 125 parts by mass. As the particle diameter of toner is reduced, the leakage of toner more easily occurs at the end part of a development sleeve. Since the leakage of magnetic toner is prevented at a magnetic sealing part by the magnet field at the magnet ends arranged in a development sleeve and the magnet field of a magnetic sealing member, a higher magnetic substance amount in the toner is required when the particle diameter of toner is reduced to increase the electric charge amount. In an electrophotographic cartridge having the magnetic seal of the present invention, a magnetic substance amount in toner of 50 parts by mass or more and less than 125 parts by mass is effective for prevention of the leakage of toner.

A magnetic substance amount in toner of less than 50 parts by mass has a weak response to the magnetic force of the magnetic sealing member, causing the leakage of toner. A magnetic substance amount in toner of 125 parts by mass or more allows a large amount of toner to be captured by the magnetic sealing member, accelerating the degradation of toner.

Measuring Method

Magnetic Properties

The residual magnetic flux density (Br), the intrinsic coercive force (iHc) and the maximum energy product (BHmax) were measured according to JIS C 2501:1998, using a B—H analyzer BH-5501 made by Denshijiki Industry Co., Ltd. as a measuring device.

Composition Analysis

Hydrochloric acid (nitric acid or sulfuric acid may be used depending on the state of dissolution) is used to prepare a solution to be measured by ICP mass spectrometry or ICP optical emission spectrometry. The aqueous solution sample is atomized and introduced to inductively coupled plasma (ICP) as an ion source, allowing ionized elements in plasma to be separated and detected with a quadrupole mass spectrometer for element analysis. Boron (B) is analyzed by ICP optical emission spectrometry.

Measurement of Particle Diameter of Toner

In the present invention, the average particle diameter and the particle size distribution of toner are analyzed with a Coulter Counter TA-II (made by Beckman Coulter, Inc.), but a Coulter Multisizer (made by Beckman Coulter, Inc) can also be used. A first class grade sodium chloride was used to prepare an electrolyte of 1% NaCl aqueous solution. For example, ISOTON R-II (made by Coulter Scientific Japan Co.) may be used. Into 100 ml to 150 ml of electrolyte aqueous solution, 0.1 to 5 ml of a surfactant as dispersant, in particular alkylbenzene sulfonate, was added. Subsequently, 2 to 20 mg of a measurement sample was added. A dispersion treatment of the electrolyte including the suspended sample was performed with an ultrasonic disperser for about 1 to 3 minutes. The volume and the number of toner particles of 2.00 μm or more were measured with the measurement device having an aperture of 100 μm, so that the volume distribution and the number distribution were calculated. The weight average particle diameter (D4) (the median of each channel is the representative value for each channel) of the present invention was obtained based on the weight obtained from the volume distribution. The channels for use included 13 channels of 2.00 to 2.52 μm, 2.52 to 3.17 μm, 3.17 to 4.00 μm, 4.00 to 5.04 μm, 5.04 to 6.35 μm, 6.35 to 8.00 μm, 8.00 to 10.08 μm, 10.08 to 12.70 μm, 12.70 to 16.00 μm, 16.00 to 20.20 μm, 20.20 to 25.40 μm, 25.40 to 32.00 μm, and 32.00 to 40.30 μm.

Embodiments of the present invention are described in the following.

### Example 1

Magnetic powder having compositions described in Table 1 and nylon 12 as a binder resin was compounded into the composition described in Table 1. A yoke member (magnetic flux converging layer) was made of stainless steel. The yoke member was arranged in a mold cavity. Subsequently, a raw material composition including the magnetic powder and the resin binder was injected into a mold by an injection molding machine, so as to be molded into the shape of the magnetic sealing member.

A shaped product of magnetic sealing member having a resin magnet with a width of 3 mm, a magnetic flux converging layer (yoke member) with a width of 1 mm, and a circular arc with a radius R of 10.2 mm was obtained as illustrated in FIG. 1.

Magnetization was performed after molding, using a magnetic field generating unit with magnetization coils arranged at the same positions as the positions of a magnetic pole pattern. The number of N and S magnetic poles alternately arranged in radial direction was 10.

The magnetic seal thus obtained was mounted on a cartridge of LASER SHOT LBP3100 made by Canon Inc. The cartridge was loaded with toner A or B to be described later for a toner leakage test and an image output endurance test.

The magnetic substance for use in toner can have a residual magnetic flux density (Br) of 20 mT or less, and a maximum energy product (BHmax) of 6.0 kJ/m³ or less. The magnetic substance of the Examples had a residual magnetic flux density (Br) of 5.2 mT, and a maximum energy product (BHmax) of 150 J/m³.

The toner for use is described below.

Toner A: Spherical magnetic toner (made by suspension polymerization), having a weight-average particle diameter of 8.5 μm and a magnetic substance amount of 70 parts by mass based on 100 parts by mass of the resin.

Toner B: Pulverized polyester toner, having a weight-average particle diameter of 5.5 μm and a magnetic substance amount of 115 parts by mass based on 100 parts by mass of the resin.

Evaluation results are described in Table 5. In both of a vibration test under high temperature and high humidity and a 2-m drop test, no leakage of toner occurred from a sealing part at all. In an image output endurance test under high temperature and high humidity, no degradation of toner was observed at the magnetic sealing part in evaluation after image output of 1500 sheets. As a result, an excellent image was obtained, having an image density of 1.3 or higher measured by Macbeth densitometer RD 918 (made by Macbeth) without toner fogging or toner dropping in a white portion of the image. No toner scattered within the printer was observed.

### Examples 2 to 9 and Comparative Examples 1 to 4

The compositions of the magnetic sealing members are described in Table 1 and Table 2. The magnetic properties of the obtained magnetic sealing members are described in Table 3 and Table 4.

The evaluation was performed in the same way as in Example 1. The results are described in Table 5 and Table 6.

TABLE 1

| | | Example 1 | Example 2 | Example 3 | Example 4 | Example 5 | Example 6 | Example 7 | Example 8 | Example 9 |
|---|---|---|---|---|---|---|---|---|---|---|
| | Constituent | | | | | | | | | |
| | element | | | | | | | | | |
| Magnetic | Nd: Neodymium | 6.9 | 3.2 | 11.2 | 7.1 | 6.3 | 7.2 | 6.9 | 6.2 | 7.3 |
| powder | Fe: Iron | 76.1 | 84.3 | 71.4 | 67.4 | 79.3 | 77.6 | 72.0 | 77.1 | 78.9 |
| (atomic %) | Sr: Strontium | 2.7 | 2.4 | 2.4 | 2.0 | 0.2 | 2.6 | 2.5 | 1.3 | 0.7 |
| | Ba: Barium | 0.0 | 0.0 | 1.6 | 0.4 | 0.0 | 0.0 | 0.0 | 0.0 | 0.0 |
| | Pr: Praseodymium | 2.5 | 0.3 | 0.0 | 4.5 | 1.9 | 2.4 | 2.3 | 2.2 | 2.2 |
| | La: Lanthanum | 1.9 | 0.3 | 0.6 | 4.0 | 1.4 | 1.9 | 1.8 | 1.7 | 1.8 |
| | B: Boron | 7.1 | 6.6 | 8.3 | 7.3 | 6.1 | 5.5 | 11.9 | 6.4 | 6.5 |
| | Si: Silicon | 0.0 | 1.3 | 0.0 | 0.0 | 0.0 | 0.0 | 0.0 | 0.0 | 0.0 |
| | In: Indium | 0.0 | 0.0 | 0.4 | 0.0 | 0.0 | 0.0 | 0.0 | 0.0 | 0.0 |
| | P: Phosphorus | 0.0 | 0.0 | 0.8 | 0.0 | 0.0 | 0.0 | 0.0 | 0.0 | 0.0 |
| | Al: Aluminum | 2.8 | 1.6 | 3.3 | 7.3 | 4.8 | 2.8 | 2.6 | 5.1 | 2.6 |
| | Resin | | | | | | | | | |
| Binder resin | Nylon 12 | 8.7 | 0.0 | 0.0 | 7.0 | 7.5 | 4.4 | 5.5 | 6.4 | 8.7 |
| (part by mass of | Polyphenylene | 0.0 | 12.7 | 5.5 | 0.0 | 0.0 | 0.0 | 0.0 | 0.0 | 0.0 |
| resin based on | sulfide | | | | | | | | | |
| 100 parts by | | | | | | | | | | |
| mass of magnet | | | | | | | | | | |
| composition) | | | | | | | | | | |

TABLE 2

| | | Comparative | Comparative | Comparative | Comparative |
|---|---|---|---|---|---|
| | | Example 1 | Example 2 | Example 3 | Example 4 |
| | Constituent element | | | | |
| Magnet powder (atomic %) | Nd: Neodymium | 2.6 | 12.6 | 6.0 | 0.0 |
| | Fe: Iron | 89.1 | 59.5 | 81.9 | 95.7 |
| | Sr: Strontium | 3.6 | 1.8 | 0.0 | 4.3 |
| | Ba: Barium | 0.0 | 0.0 | 0.0 | 0.0 |
| | Pr: Praseodymium | 0.0 | 0.0 | 5.0 | 0.0 |
| | La: Lanthanum | 0.0 | 0.0 | 4.1 | 0.0 |
| | B: Boron | 3.4 | 7.0 | 0.0 | 0.0 |
| | Si: Silicon | 0.0 | 0.0 | 0.0 | 0.0 |
| | In: Indium | 0.0 | 2.0 | 0.0 | 0.0 |
| | P: Phosphorus | 0.0 | 4.4 | 0.0 | 0.0 |
| | Al: Aluminum | 1.4 | 12.7 | 2.9 | 0.0 |
| | Resin | | | | |
| Binder resin (part by mass of | Nylon 12 | 7.5 | 14.5 | 16.0 | 0.0 |
| resin based on 100 parts by | Polyphenylene sulfide | 0.0 | 0.0 | 0.0 | 2.0 |
| mass of magnet composition) | | | | | |

TABLE 3

| | | Exam- | Exam- | Exam- | Exam- | Exam- | Exam- | Exam- | Exam- | Exam- |
|---|---|---|---|---|---|---|---|---|---|---|
| Property | Unit | ple 1 | ple 2 | ple 3 | ple 4 | ple 5 | ple 6 | ple 7 | ple 8 | ple 9 |
| Br: Residual magnetic flux | mT | 332 | 270 | 498 | 340 | 300 | 360 | 305 | 418 | 469 |
| density | | | | | | | | | | |
| iHc: Intrinsic coercive force | kA/m | 564 | 405 | 845 | 750 | 680 | 480 | 504 | 671 | 703 |
| BHmax: Maximum energy | kJ/m³ | 18.3 | 11.0 | 40.0 | 19.2 | 22.3 | 19.1 | 17.0 | 28.7 | 36.3 |
| product | | | | | | | | | | |
| Br/iHc: Residual magnetic flux | (mT)/(kA/m) | 0.59 | 0.67 | 0.59 | 0.45 | 0.44 | 0.75 | 0.61 | 0.62 | 0.67 |
| density/Intrinsic coercive force | | | | | | | | | | |

TABLE 4

| | | Comparative | Comparative | Comparative | Comparative |
|---|---|---|---|---|---|
| Property | Unit | Example 1 | Example 2 | Example 3 | Example 4 |
| Br: Residual magnetic flux density | mT | 130 | 200 | 550 | 266 |
| iHc: Intrinsic coercive force | kA/m | 350 | 950 | 1400 | 330 |
| BHmax: Maximum energy product | kJ/m³ | 8.5 | 45.0 | 50.0 | 9.8 |
| Br/iHc: Residual magnetic flux | (mT)/(kA/m) | 0.37 | 0.21 | 0.39 | 0.79 |
| density/Intrinsic coercive force | | | | | |

TABLE 5

| | | Example 1 | Example 2 | Example 3 | Example 4 | Example 5 | Example 6 | Example 7 | Example 8 | Example 9 |
|---|---|---|---|---|---|---|---|---|---|---|
| Toner | | A | A | A | A | B | B | B | B | B |
| Toner leakage test with vibration under | | Good | Good/Fair | Good | Good | Good | Good | Good | Good | Good |
| high temperature and high humidity | | | | | | | | | | |
| (32.5° C., 85%) | | | | | | | | | | |
| Toner leakage test by 2-m drop test | | Good | Good/Fair | Good | Good | Good | Good | Good | Good | Good |
| Image output | Image density | Good | Good | Good | Good | Good | Good | Good | Good | Good |
| endurance test under | Toner fogging | Good | Good/Fair | Good/Fair | Good | Good | Good | Good | Good | Good |
| high temperature and | Toner | Good | Good | Good/Fair | Good | Good | Good | Good | Good | Good |
| high humidity | dropping | | | | | | | | | |
| (32.5° C., 85%) | Inside toner | Good | Good/Fair | Good/Fair | Good | Good | Good | Good | Good | Good |
| | scattered | | | | | | | | | |

TABLE 6

| | | Comparative | Comparative | Comparative | Comparative |
|---|---|---|---|---|---|
| | | Example 1 | Example 2 | Example 3 | Example 4 |
| Toner | | A | A | B | B |
| Toner leakage test with vibration under high temperature and | | Poor | Good | Good | Fair/Poor |
| high humidity (32.5° C., 85%) | | | | | |
| Toner leakage test by 2-m drop test | | Poor | Good | Good | Fair |
| Image output endurance test under | Image density | Good/Fair | Fair/Poor | Fair/Poor | Good/Fair |
| high temperature and high humidity | Toner fogging | Fair/Poor | Fair/Poor | Poor | Fair |
| (32.5° C., 85%) | Toner dropping | Fair | Fair/Poor | Fair/Poor | Fair/Poor |
| | Toner scattered in | Poor | Poor | Poor | Fair/Poor |
| | machine | | | | |

TABLE 7

| Evaluation criteria | | Good | Good/Fair | Fair | Fair/Poor | Poor |
|---|---|---|---|---|---|---|
| Toner leakage test with vibration under high | | No leakage/ | Small amount of | Certain amount of | Rather large | Large amount of |
| temperature and high humidity (32.5° C., 85%) | | “Useful” | leakage/ | leakage/ | amount of leakage/ | leakage/ |
| | | | “Useful” | “Useless” | “Useless” | “Useless” |
| Toner leakage test by 2-m drop test | | No leakage/ | Small amount of | Certain amount of | Rather large | Large amount of |
| | | “Useful” | leakage/ | leakage/ | amount of leakage/ | leakage/ |
| | | | “Useful” | “Useless” | “Useless” | “Useless” |
| Image output endurance test | Image density | Density of 12 or | Density of 1.0 or | Density of 0.9 | Density of 0.7 | Density of less than |
| under high temperature and | | higher | higher | to 1.0 | to 0.9 | 0.7 |
| high humidity (32.5° C., | Toner fogging | Amount of toner | Amount of toner | Amount of toner | Amount of toner | Amount of toner |
| 85%) | | fogging of 1.5% | fogging of 1.6% | fogging of 2.6% to | fogging of 3.6% to | fogging of 4.1% or |
| | | or less/ | to 2.5%/ | 3.5%/ | 4.0%/ | more/ |
| | | “Useful” | “Useful” | “Useless” | “Useless” | “Useless” |
| | Toner | None/ | Incidence of | Incidence of about | Incidence of about | Incidence of about |
| | dropping | “Useful” | about one image | one image per 100 | one image per 50 | one image per 30 |
| | | | per 1500 images/ | images/ | images/ | images, with dirty |
| | | | “Useful” | “Useless” | “Useless” | rear side of image/ |
| | | | | | | “Useless” |
| | Toner | None/ | Almost none/ | Small amount of | Certain amount of | Large amount of |
| | scattered in | “Useful” | “Useful” | toner scattered/ | toner scattered/ | toner scattered/ |
| | machine | | | “Useless” | “Useless” | “Useless” |

Toner Fogging

The toner fogging on an image was measured by a reflection densitometer (Reflectometer Model TC-6DS made by Tokyo Denshoku Co., Ltd). The amount of toner fogging is obtained from (Ds)−(Dr), wherein Ds(%) represents the worst reflection density value of the white background after image formation and Dr(%) represents average reflection density of a transfer material before image formation.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-168430, filed Jul. 30, 2012, which is hereby incorporated by reference herein in its entirety.

What is claimed is:

1. An electrophotographic magnetic sealing member for sealing a magnetic toner having a weight-average particle diameter of 5.0 μm or more and less than 9.0 μm with a magnetic substance amount in the magnetic toner of 50 parts by mass or more and less than 125 parts by mass, the electrophotographic magnetic sealing member comprising a magnetic material and a binder resin,
wherein the magnetic material at least comprises neodymium (Nd) and iron (Fe), and further comprises at least one element selected from the group consisting of strontium (Sr) and barium (Ba), at least one element selected from the group consisting of praseodymium (Pr) and lanthanum (La), at least one element selected from the group consisting of boron (B), silicon (Si), indium (In), and phosphorus (P), and an aluminum (Al) element,
wherein the magnetic material has a residual magnetic flux density (Br) of 270 mT or more and 500 mT or less, an intrinsic coercive force (iHc) of 400 kA/m or more and 850 kA/m or less, and a maximum energy product (BHmax) of 10.0 kJ/m³ or more and 40.0 kJ/m³ or less, and
wherein the electrophotographic magnetic sealing member contains 3.0 parts by mass or more and 15.0 parts by mass or less of the binder resin based on 100.0 parts by mass of the magnetic material.

2. The electrophotographic magnetic sealing member according to claim 1, wherein the magnetic material at least comprises 3.0 atomic % or more and 12.0 atomic % or less of neodymium (Nd) and 65.0 atomic % or more and 85.0 atomic % or less of iron (Fe), and further comprises 0.10 atomic % or more and 4.0 atomic % or less of at least one element selected from the group consisting of strontium (Sr) and barium (Ba), 0.10 atomic % or more and 9.0 atomic % or less of at least one element selected from the group consisting of praseodymium (Pr) and lanthanum (La), 4.0 atomic % or more and 15.0 atomic % or less of at least one element selected from the group consisting of boron (B), silicon (Si), indium (In), and phosphorus (P), and 1.5 atomic % or more and 8.0 atomic % or less of an aluminum (Al) element.

3. The electrophotographic magnetic sealing member according to claim 1, wherein the magnetic material at least comprises 4.5 atomic % or more and 10.0 atomic % or less of neodymium (Nd) and 67.0 atomic % or more and 80.0 atomic % or less of iron (Fe), and further comprises 0.20 atomic % or more and 3.0 atomic % or less of at least one element selected from the group consisting of strontium (Sr) and barium (Ba), 3.0 atomic % or more and 8.5 atomic % or less of at least one element selected from the group consisting of praseodymium (Pr) and lanthanum (La), 5.0 atomic % or more and 11.5 atomic % or less of at least one element selected from the group consisting of boron (B), silicon (Si), indium (In), and phosphorus (P), and 2.0 atomic % or more and 7.5 atomic % or less of an aluminum (Al) element.

4. The electrophotographic magnetic sealing member according to claim 1, wherein the magnetic material has a residual magnetic flux density (Br) of 290 mT or more and 480 mT or less, an intrinsic coercive force (iHc) of 420 kA/m or more and 750 kA/m or less, and a maximum energy product (BHmax) of 12.0 kJ/m³ or more and 38.0 kJ/m³ or less.

5. The electrophotographic magnetic sealing member according to claim 1, wherein the binder resin is contained in an amount of 4.0 parts by mass or more and 13.0 parts by mass or less.

6. The electrophotographic magnetic sealing member according to claim 5, wherein the binder resin comprises at least one resin selected from the group consisting of polyamide, polyphenylene sulfide, polystyrene, polyethylene, polypropylene, and polyethylene terephthalate.

7. An electrophotographic cartridge comprising the electrophotographic magnetic sealing member according to claim 1.
